(19) United States
(12) Patent Application Publication
(10) Pub. No.: US 2007/0052198 A1
(43) Pub. Date: Mar. 8, 2007

(54) Tricycle neck connector

(75) Inventor: Ray G. Kelly, St. Louis, MO (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(73) Assignee: Angeles group, LLC

(21) Appl. No.: 11/210,361

(22) Filed: Aug. 24, 2005

(51) Int. Cl. B62M 1/02

(52) U.S. Cl. 280/259

(57) ABSTRACT

In one embodiment of the present invention, a children's tricycle assembly comprises a front frame including a front wheel and a steering assembly, a rear frame including two rear wheels and a seat, and a connecting member connected to the front frame and selectively coupled to the rear frame. The connecting member includes a rearward extension portion, the rear extension portion having one or more tabs. The extension portion is at least partially received in a tube of the rear frame, the tube having one or more openings designed for receipt of the tabs to substantially lock the rear frame to the connecting member, thereby connecting the rear frame to the front frame.

### FIELD OF THE INVENTION

The present invention relates to tricycles and in particular an improved neck connector for a tricycle.

### BACKGROUND OF THE INVENTION

A popular and traditional children's riding vehicle is a tricycle. A standard tricycle includes three wheels, a frame with a seat, and handlebars or a steering wheel allowing a child to steer the tricycle. In the traditional arrangement, a tricycle is bulky and takes up considerable space during transport, including shipment, and is thus costly to transport. Attempts to remedy this problem sometimes involve tricycle kit assemblies that are difficult to assemble, often requiring one or more tools. There is a need for an improved tricycle assembly. Certain embodiments of the present invention address these and other needs.

### SUMMARY OF THE INVENTION

In one preferred embodiment of the present invention, a tricycle assembly comprises a rear frame, a front frame, and a connecting member. The rear frame includes two rear wheels and a seat, and the front frame includes a front wheel and a steering assembly. Preferably, the connecting member is connected to the front frame and selectively coupled to the rear frame. In certain preferred embodiments, the connecting member includes a rearward extension portion having one or more tabs, the extension portion being at least partially received in a tube of the rear frame. The tube has one or more corresponding openings designed for receipt of the one or more tabs to substantially lock the rear frame to the connecting member.

In another preferred embodiment of the present invention, a kit comprises a rear frame of a tricycle, a front frame of a tricycle and a connecting member connected to the front frame. In typical embodiments, the rear frame includes two rear wheels and a seat, and the front frame includes a front wheel and a steering assembly. Preferably, the connecting member selectively couples to the rear frame by being slidably received in a corresponding passage in the rear frame. In preferred embodiments, the connecting member includes tabs received in corresponding slots in the rear frame to substantially lock the rear frame to the front fork.

In yet another preferred embodiment of the present invention, a kit comprises a rear frame of a tricycle, a front fork of a tricycle, and a connecting member. In typical embodiments, the rear frame includes two rear wheels and a seat, and the front fork includes a front wheel and a steering mechanism. In preferred embodiments, the connecting member is connectible to the front frame and selectively couples to the rear frame, the connecting member being slidably received in a corresponding passage in the rear frame. In certain embodiments, a detent mechanism connects the rear frame to the connecting member to substantially lock the rear frame to the front fork.

In a further preferred embodiment, a method comprises providing a rear frame of a tricycle and providing a front frame of a tricycle with a connecting member connected to the front frame. Preferably, the connecting member includes a rearward portion configured to selectively couple to the rear frame. In preferred embodiments, the rearward portion includes one or more tabs designed to be received in one or more slots of the rear frame. Additionally, the method comprises connecting the rear frame to the front frame, wherein the connecting includes inserting the rearward portion in a passage of the rear frame to a position whereby the tabs are received in the slots.

It is an object of certain embodiments of the present invention to provide an improved tricycle assembly.

Further objects, features and advantages of the present invention shall become apparent from the detailed drawings and descriptions provided herein.

### DESCRIPTION OF THE DRAWINGS

FIG. 1 is a perspective view of a preferred embodiment of the present invention.

FIG. 2 is a perspective view of another preferred embodiment of the present invention.

FIG. 3 is an exploded view of the connecting mechanism of FIGS. 1 and 2.

FIG. 4 is a perspective view of the connecting mechanism of FIGS. 1, 2 and 3.

FIG. 5 is another perspective view of the connecting mechanism of FIGS. 1, 2 and 3.

### BRIEF DESCRIPTION OF PREFERRED EMBODIMENTS

While the present invention may be embodied in many different forms, for the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Illustrated in the accompanying figures is a children's tricycle including a connecting mechanism. In certain embodiments, the tricycle includes a connecting mechanism assembly which provides for easier shipping and storage of the tricycle.

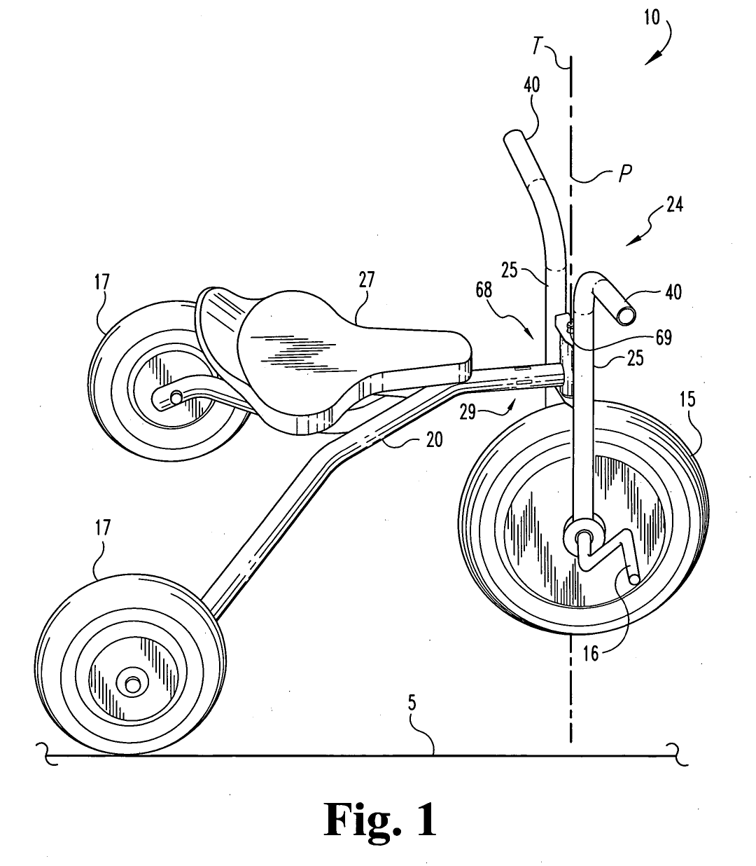

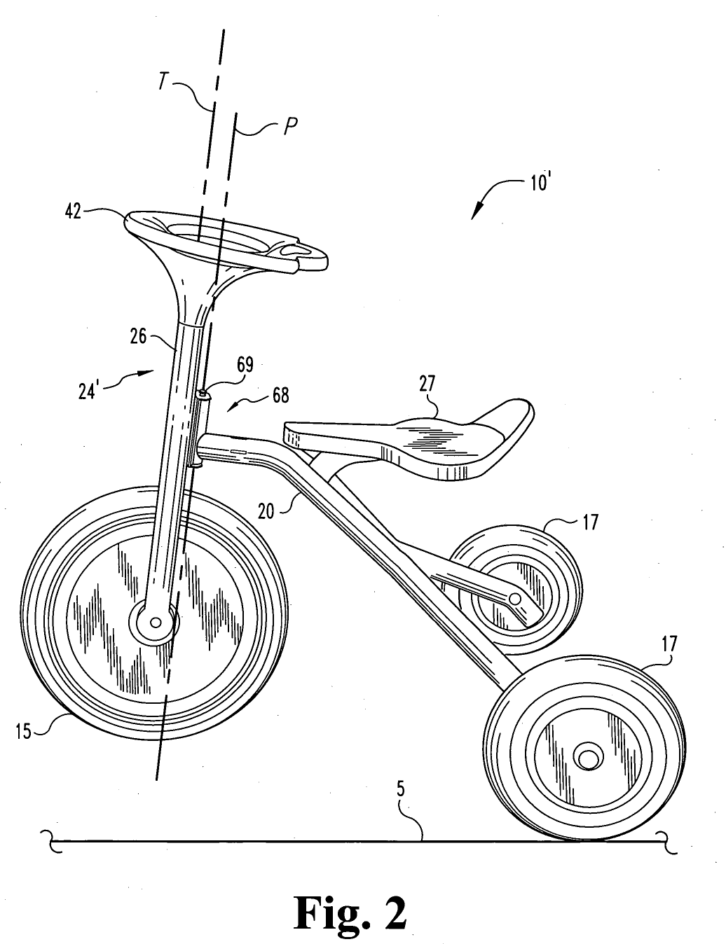

Illustrated in a preferred embodiment in FIG. 1 is a tricycle 10 for use on a support surface 5. Additionally, illustrated in a preferred embodiment in FIG. 2 is a tricycle 10′ for use on a support surface 5. The tricycles include three wheels such as a front wheel 15 and rear wheels 17. Rear wheels 17 are connected to a rear frame 20 which typically includes a seat 27.

Referring to FIG. 1, a front frame 24 includes two mounting rods 25 extending from front wheel 15. Front frame 24 is connected via a connecting assembly 68 to a forward portion 29 of rear frame 20. In preferred embodiments, connecting assembly 68 can be permanently connected to front frame 24 and can selectively couple to rear frame 20. Tricycle 10 includes a crank 16, optionally with pedals, attached to or forming the axle of front wheel 15 for the user to propel the front wheel and thus the tricycle.

Tricycle 10 includes, in the embodiment illustrated in FIG. 1, a set of handle bars 40 extending from mounting rods 25. In another preferred embodiment, as illustrated in FIG. 2, tricycle 10′ includes a steering wheel assembly 42. Tricycle 10′ is a non-pedal or “push” style tricycle. Tricycle 10′ is substantially similar to tricycle 10 and functions in a substantially similar manner as tricycle 10. In the embodiment illustrated in FIG. 2, a front frame 24′ includes two mounting rods connected above the wheel with a bracket to form a fork, with a central post 26 extending upward. Wheel assembly 42 may be centrally or eccentrically mounted to front frame 24′. Assembly 68 can be connected directly to front frame 24 and/or 24′, or connected via a frame connection piece (not shown).

Handle bars 40 and steering wheel assembly 42 are operatively coupled via connecting assembly 68 to forward portion 29 of rear frame 20. Handle bars 40 and steering wheel assembly 42 operate, when desired, to cause wheel 15 to turn, guiding tricycles 10 and 10′ in a desired direction. In certain preferred embodiments, front frame 24 and/or 24′, along with handle bars 40 and/or wheel assembly 42, are formed in blow-molded or injected molded plastic. Other embodiments can be made from wood, metal, rubber or a hard plastic.

Connecting assembly 68 includes a connection pivot piece 69. In certain preferred embodiments, pivot piece 69 is a bolt having a retaining nut, clip or pin, or a similar pivot axle. Pivot piece 69 defines a generally vertical pivot axis P through which the front frame 24 (and 24′) and front wheel 15 of tricycle 10 (and 10′) can pivot relative to the rear frame 20 and rear wheels 17.

As a preferred optional feature of certain embodiments, front wheel 15 is mounted to the front frame 24 and/or 24′ and together they define a substantially vertical turning axis T. Regarding tricycle 10′, turning axis T is parallel to and offset forward from pivot axis P. This offset mounting of turning axis T from pivot axis P provides a lever moment between the turning position and the pivot point, allowing the user to more easily turn front wheel 15 relative to the rear frame 20. In a preferred embodiment, pivot axis P and turning axis T of tricycle 10 are parallel.

In certain preferred embodiments, the steering mechanism is connected to the front frame at an offset or eccentric point. This offset mounting of the steering mechanism provides a lever moment between a mounting axis (not shown) and the pivot axis P, allowing the user to more easily turn the steering wheel and front wheel. The mounting axis may also be offset from turning axis T to provide a further mechanical advantage. In certain embodiments, this further allows the handle bars 40 and/or wheel assembly 42 to be mounted more closely adjacent to seat 27, allowing a small child's arms to be less extended. In alternate embodiments, the mounting axis is aligned with one or both of the pivot axis P and the turning axis T.

In certain preferred embodiments, handle bars 40 and/or wheel assembly 42 are preferably mounted at a non-parallel angle to the ground. The angled mount of the handle bars or the wheel assembly facilitates and encourages a child or other user to more comfortably and instinctively hold the steering wheel with the user's arm over or beside the handle bars or the wheel assembly. The handle bars or the wheel assembly may optionally be configured to allow a user to steer one handed in a balanced, central position.

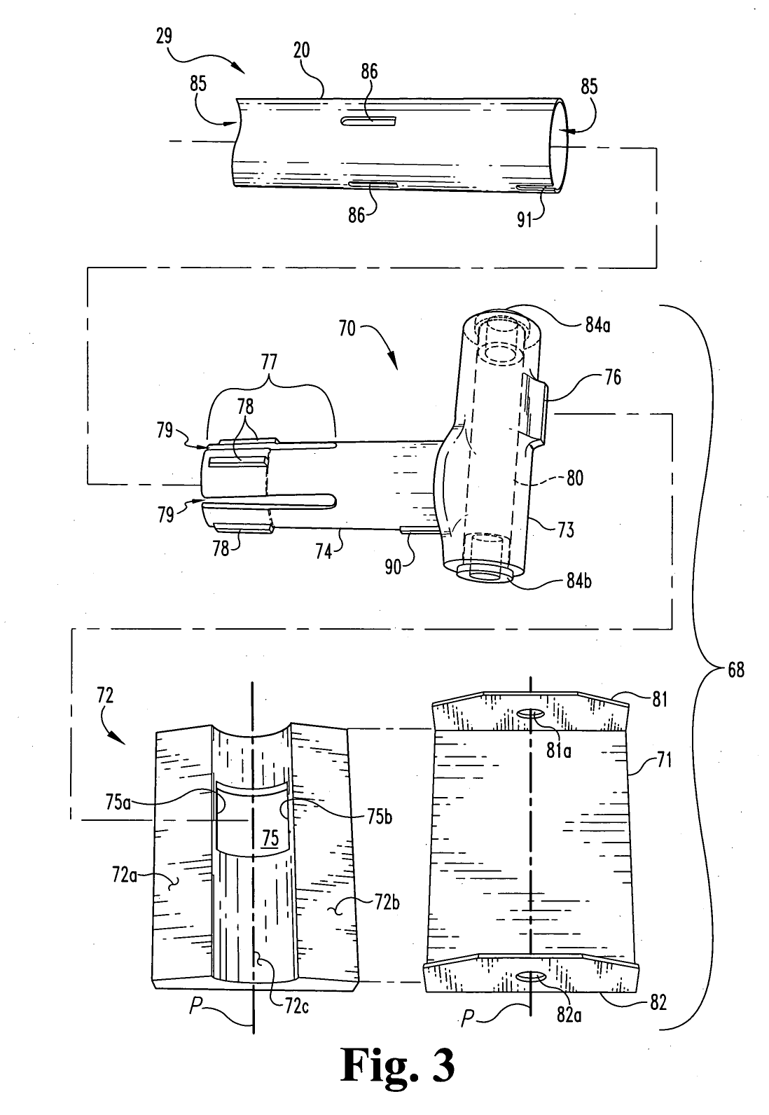

FIG. 3 illustrates an exploded view of an example connecting assembly 68 along with forward portion 29 of rear frame 20. In certain embodiments, connecting assembly 68 includes a connecting member 70, a bracket 71, and a plate 72. FIG. 3 shows a straight, perspective view of bracket 71 and plate 72, and a side view of connecting member 70 and rear frame 20, for clarity. In the illustrated embodiment, connecting member 70 includes a front portion 73 and a rearward extending portion 74. In one embodiment, portions 73 and 74 are substantially cylindrically shaped with circular cross-sections. Further, portions 73 and 74 are preferably positioned substantially perpendicular to each other, such as a T-bar configuration. However, it should be appreciated that the portions 73 and 74 can be configured and positioned differently as would occur to one skilled in the art.

Connecting member 70 is preferably a single, molded, plastic piece. However, it should be appreciated that member 70 can be made from a different suitable material as would occur to one skilled in the art. Bracket 71 defines a pivot axis P and includes two flanges 81 and 82, including holes 81a and 81b, respectively. In a preferred embodiment, plate 72 is configured to be positioned on bracket 71, extending between flanges 81 and 82, with pivot axis P passing through a central cut-away portion 72c. In one embodiment, plate 72 and bracket 71 are made of a substantially metal material; however, it is contemplated that plate 72 and bracket 71 can be made from different suitable materials as would occur to one skilled in the art.

Additionally, in the illustrated embodiment, plate 72 includes an opening 75. Opening 75 has side edges 75a and 75b. In one embodiment, the plate can be of generally uniform thickness, in other words, being generally flat. In other embodiments, such as the embodiment illustrated in FIG. 3, plate 72 can have ramped portions 72a and 72b defining sections of increasing height towards a pivot axis P and plate 72 can further include the substantially arcuate cut-away portion 72c. Portion 72c preferably receives front portion 73. Preferably, front portion 73 includes a radius substantially equal to or slightly smaller than the radius of cut-away portion 72c. In certain embodiments, opening 75 extends through the thickness of plate 72. In alternative embodiments, opening 75 extends only partially into plate 72.

Referring additionally to FIG. 3, in a preferred embodiment, front portion 73 includes a nub 76 which is received in opening 75 when connecting assembly 68 is assembled. Nub 76 is a forward flange or bumper to limit the pivot distance of front frame 24 and/or 24′ and wheel 15 by providing stops. In preferred embodiments, the sidewalls of opening 75 are at least as thick as nub 76, so that nub 76 does not contact bracket 71 in a manner that would prevent movement of nub 76 in opening 75. Alternatively, the plate can be configured such that the opening is spaced a distance from the bracket, and the nub can be larger, yet the space retains the nub extending through the opening from contacting the bracket.

Additionally, in further preferred embodiments, rearward extension portion 74 includes an optional tapered portion 77 with a decreasing diameter, one or more tabs 78, and one or more divisions 79. Divisions 79 preferably extend from the free end of rearward extension portion 74 inward toward front portion 73. However, it should be appreciated that divisions 79 can be positioned and configured differently along portion 74 as would occur to one skilled in the art. In one embodiment, there are four divisions positioned about the circumference of rearward extension portion 74, the four divisions defining four sections with a tab. In one embodiment, the four tabs 78 and the four divisions 79 are positioned equidistant each other about portion 74. Preferably, tabs 78 are generally rectangular in shape with a uniform thickness. In certain preferred embodiments, the thickness of tabs 78 is equal to or less than the thickness of frame 20. Alternatively, tabs 78 can increase in thickness in a direction toward the front portion 73. The tabs are preferably inwardly resilient, yet outwardly biased to return to an outward position.

In a preferred embodiment, front portion 73 includes a shaft 80 extending therethrough configured for receipt of pivot piece 69, such as a pivot bolt. Shaft 80 is aligned with, when assembled, pivot axis P. Further, in preferred embodiments, the shaft receives pivot piece 69 to secure connecting member 70 to bracket 71 and plate 72. In certain embodiments, bearings 84a and 84b are positioned at shaft ends 81a and 82.

FIG. 3 further illustrates forward portion 29 of rear frame 20. Frame 20 defines an inner passage 85 and includes one or more slots 86 designed for receipt of tabs 78. In a preferred embodiment, there are a corresponding number of slots 86 to tabs 78 and slots 86 are generally rectangular in shape. It is contemplated that slots and tabs of other shapes, dimensions, and configurations are possible. In certain preferred embodiments, tabs 78 release into slots 86 to a position where slots 86 are flush with an outer surface of rear frame 20, with sufficient clearances and tolerances being understood. Connecting assembly 68 can further include an alignment tab 90 received in a slot 91. The alignment tab and slot arrangement ensure proper alignment of rear frame 20 relative to connecting member 70 during assembly.

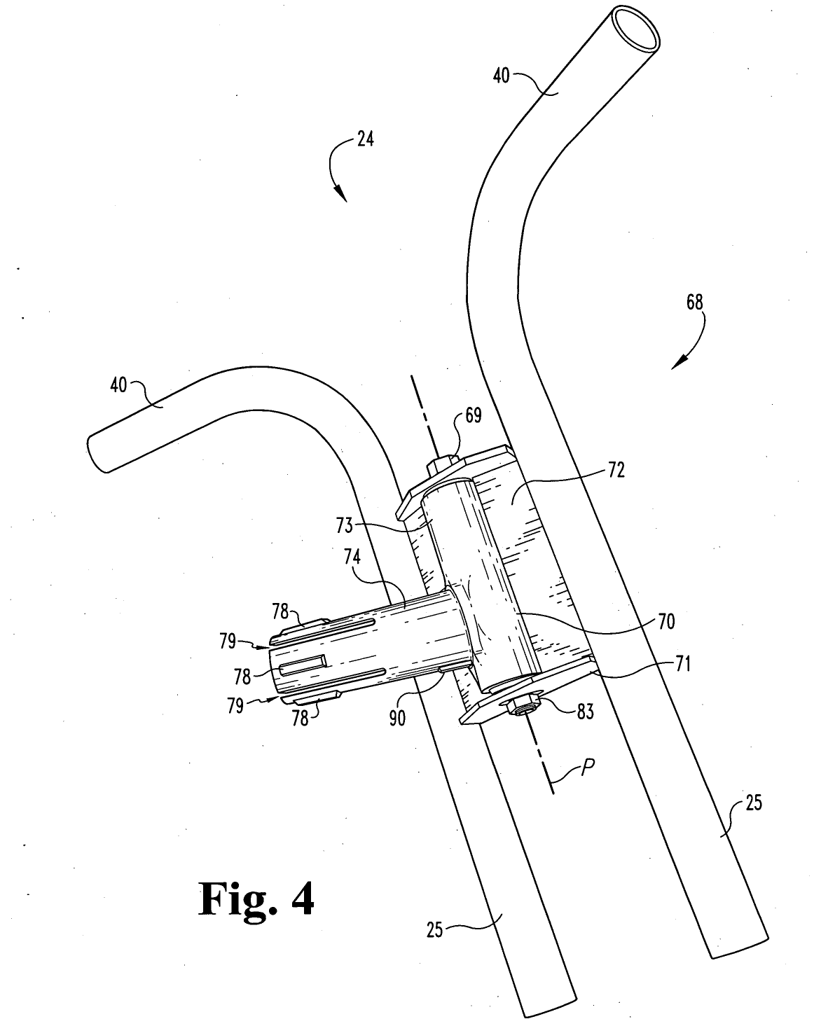

As illustrated in FIG. 4, connecting member 70 can be secured to bracket 71 via pivot piece 69, thus retaining plate 72 in position. In certain embodiments, pivot piece 69 is secured to bracket 71 with a nut 83 or similar retaining piece. In a preferred embodiment, nut 83 is a lock nut including a plastic threaded inner surface. The lock nut is a safety feature preventing disengagement of the pivot piece, such as a bolt, from the bracket plate. Optionally, other retaining pieces, or a permanent process such as cold forming is used to permanently connect the pivot piece to the bracket plate. Cold forming uses force to depress and deform an end of the pivot piece on a bottom side of the bracket plate, the deformed end having a large enough area to prevent the pivot piece from backing out. Using cold forming eliminates the need for a nut and does not require assembly by a user. It should be appreciated that any appropriate method of securing the pivot piece to the bracket plate can be used as would occur to one skilled in the art.

In preferred embodiments, connecting assembly 68 is configured such that nub 76 is received in opening 75 to limit the turning ability of tricycle 10 and 10′. Bracket 71 can be mounted to mounting rods 25 (FIG. 1) of front frame 24 or a central post 26 (FIG. 2) of front frame 24′ by various methods as would generally occur to one skilled in the art, such as welding.

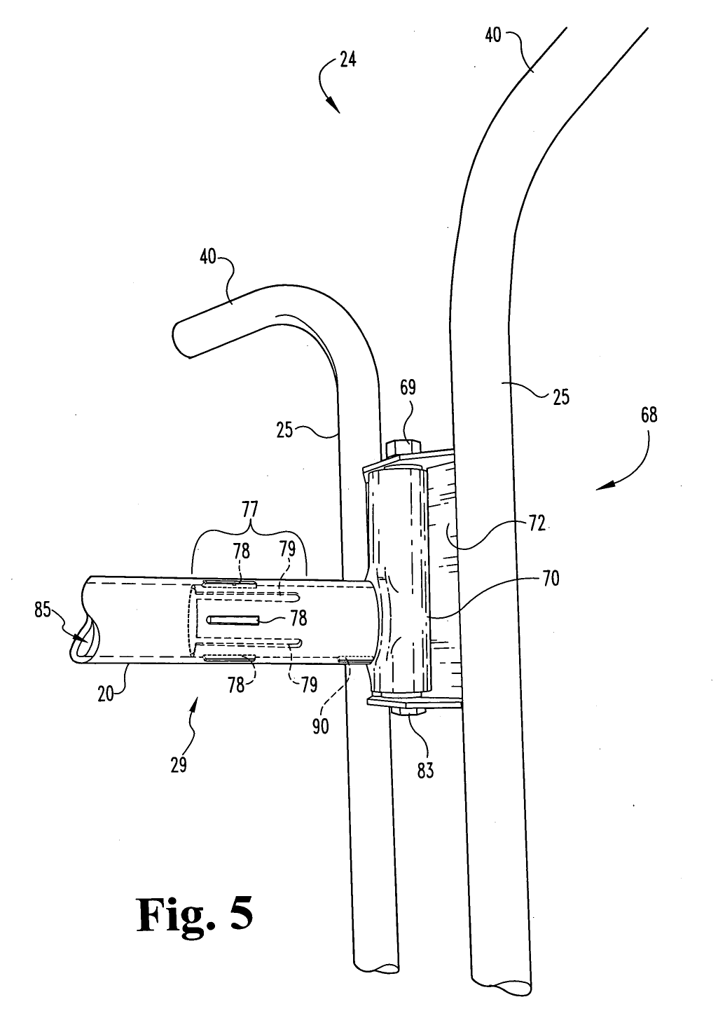

Referring to FIG. 5, rear frame 20 defines channel 85 at forward portion 29 configured to accommodate rearward extension portion 74. The diameter of channel 85, or the inner diameter of rear frame 20, is approximately the same as or slightly larger than the outer diameter of rearward extension portion 74, which allows for insertion of rearward extension portion 74 in channel 85. Optional tapered portion 77 and divisions 79 may assist in the insertion of portion 74 in channel 85, as will be described below.

Referring generally to FIGS. 1-5, the assembly of a tricycle using connecting assembly 68 is described hereafter. In one preferred embodiment, a tricycle assembly is provided as a kit containing two pieces, rear frame 20 and front frame 24 with connecting assembly 68 pre-assembled with front frame 24. Alternatively, the tricycle assembly is provided as three primary sets, including the rear frame, the front frame, and the components of the connecting assembly. The tricycle kit assembly provides for easier and more cost-effective shipment and easier assembly of the tricycle.

In a preferred embodiment, bracket 71 is permanently mounted to front frame 24 or 24′. Plate 72 is positioned adjacent bracket 71 and the front portion 73 of connecting member 70 is positioned in cut-way portion 72c of plate 72. In certain embodiments, pivot piece 69 is inserted through hole 81a of the bracket, down through shaft 80 of connecting member front portion 73, and through hole 82a. The pivot piece is secured in position, for example with nut 83 threaded onto the end of a bolt used as pivot piece 69 to secure the bolt in position. In certain preferred embodiments, nub 76, disposed on front portion 73, is received at least partially in opening 75 to operate as a steering limiter for the tricycle.

Rearward extension portion 74 is inserted in inner passage 85 of rear frame 20 at forward portion 29. In preferred embodiments, during insertion of portion 74 in passage 85, portion 74 contracts by way of divisions 79 to encourage full insertion. Further, tabs 78 preferably are configured to depress during insertion of portion 74 in passage 85. Portion 74 is preferably inserted a sufficient distance into passage 85 to a position where tabs 78 spring outward when aligned with slots 86 to engage the slots and to lock the rear frame to the connecting assembly. The uniform thickness of tabs 78 further assists in preventing disengagement of rearward extension portion 74 from rear frame 20, such as portion 74 sliding further in or sliding out of rear frame 20 and/or portion 74 rotating within rear frame 20. Further, in certain embodiments, tapered portion 77 will be contracted during the insertion of portion 74 in passage 85, thereby creating additional force encouraging tabs 78 outward.

During use of the tricycle, the front frame, the plate, and the bracket pivot about pivot axis P relative to the connecting assembly and the rear frame. The steering is limited such that when the handle bars or steering assembly are turned, the connecting assembly is limited in turning movement by nub 76 contacting surfaces 75a and/or 75b of opening 75 to prevent further turning of the handle bars or steering wheel.

In still further embodiments, the present invention is illustrated with a tricycle, but the connecting assembly may be used with other toy vehicles. Examples of such vehicles include bicycles, four-wheel vehicles such as toy cars, and/or toy boats.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A tricycle assembly, comprising:
a rear frame of a tricycle including two rear wheels and a seat;
a front frame of a tricycle including a front wheel and a steering assembly; and
a connecting member connected to the front frame and selectively coupled to the rear frame, said connecting member including a rearward extension portion having one or more tabs, said extension portion being at least partially received in a tube of said rear frame, said tube having one or more slots designed to engage said one or more tabs to substantially lock said rear frame to said connecting member.

2. The tricycle assembly of claim 1, wherein said rear extension portion includes one or more divisions.

3. The tricycle assembly of claim 1, further comprising an alignment tab and slot arrangement.

4. The tricycle assembly of claim 1, wherein said steering assembly is a set of handle bars.

5. The tricycle assembly of claim 1, wherein said tabs are depressible.

6. The tricycle assembly of claim 1, wherein said rearward extension portion includes a section of decreasing diameter, with the cross-sectional dimension of said section decreasing away from said front frame.

7. The tricycle assembly of claim 1, wherein said connecting member includes a front portion positioned substantially perpendicular to said rearward extension portion.

8. The tricycle assembly of claim 7, wherein said front portion of said connecting member defines a pivot axis.

9. The tricycle assembly of claim 7, wherein said connecting member is a T-bar.

10. The tricycle assembly of claim 7, wherein said rearward extension portion and said front portion are substantially cylindrical in shape having circular cross-sections.

11. The tricycle assembly of claim 7, comprising:
a bracket connected to the front frame, said bracket including two parallel flanges; and
a plate including a body portion, said plate positioned adjacent said bracket, said plate extending between said flanges, wherein said connecting member is connected to said bracket with said plate retained between said connecting member and said bracket.

12. The tricycle assembly of claim 11, wherein said body portion of said plate has sections of increasing height towards a center line of said plate, said body portion including an arcuate cut out volume designed for receipt of said front portion of said connecting member.

13. The tricycle assembly of claim 11, wherein said plate includes an opening and said front portion includes a nub configured to be received in said opening of said plate.

14. The tricycle assembly of claim 13, wherein the rotation of said nub in said opening is limited to limit steering of the tricycle assembly.

15. The tricycle assembly of claim 11, wherein a bolt connects said connecting member to said bracket, at least one of said flanges including a hole designed for receipt of said bolt.

16. The tricycle assembly of claim 15, whereby said front frame, said bracket, and said plate pivot relative to said connecting member and said rear frame, said bolt creating a pivot axis.

17. The tricycle assembly of claim 15, wherein said front portion is positionable in said arcuate cut out, extending between said tabs, said front portion including a shaft designed for receipt of said bolt.

18. The tricycle assembly of claim 15, wherein a nut threadingly contacts said bolt to secure said connecting member to said bracket.

19. A kit, comprising:
a rear frame of a tricycle including two rear wheels and a seat; and
a front frame of a tricycle including a front wheel and a steering mechanism; and
a connecting member connectible to said front frame and operable to be selectively coupled to said rear frame, said connecting member configured to be slidably received in a corresponding passage in said rear frame, wherein said connecting member includes tabs received in corresponding slots in said rear frame to substantially lock said rear frame to said front frame.

20. The kit of claim 19, wherein said connecting member includes a section of decreasing diameter in a direction away from said front frame.

21. The kit of claim 19, wherein said connecting member is pre-assembled onto said front frame.

22. The kit of claim 19, wherein said connecting member includes one or more divisions extending from a distal end of said connecting member toward said front frame and extending at least partially along a length of said connecting member.

23. The kit of claim 19, wherein:
a bracket is mounted to said front frame; and
said connecting member is connectable to said bracket with a bolt, including a plate positionable between said bracket and said connecting member

24. The kit of claim 23, whereby said front frame, said plate, and said bracket pivot relative to said connecting member and said rear frame, said bolt defining a pivot axis.

25. The kit of claim 23, wherein said connecting member includes a steering limiter nub disposed thereon and said plate includes an opening configured for receipt of said nub.
